(19) United States
(12) Patent Application Publication
(10) Pub. No.: US 2023/0102111 A1
(43) Pub. Date: Mar. 30, 2023

(54) SECURING CUSTOMER SENSITIVE INFORMATION ON PRIVATE CLOUD PLATFORMS

(71) Applicant: Lenovo Global Technology (United States) Inc., Morrisville, NC (US)

(72) Inventors: Vikram Choudhary, Bengaluru (IN); Miroslav Halas, Chapel Hill, NC (US); Andrew James Palay, Chapel Hill, NC (US); Bogdan-Cosmin Chifor, Nojorid (RO)

(21) Appl. No.: 17/491,157

(22) Filed: Sep. 30, 2021

(51) Int. Cl. H04L 9/08; G06F 9/455

(52) U.S. Cl. CPC H04L 9/0825; H04L 9/0827; H04L 9/085; G06F 9/45558; G06F 2009/45595; G06F 2009/45587

(57) ABSTRACT

A method for securing customer sensitive information on private cloud platforms includes receiving, at an on-premises computing system, sensitive information of a user. A local key of the on-premises computing system was previously encrypted by a master key stored at an off-premises computing system. The method includes sending the encrypted local key to the off-premises computing system for decryption, and receiving the decrypted local key in response to sending the encrypted local key to the off-premises computing system. The decrypted local key is decrypted from the received encrypted local key. The method includes decrypting a secret key assigned to the user, encrypting the sensitive information using the decrypted secret key, and storing the encrypted sensitive information.

### FIELD

The subject matter disclosed herein relates to data security and more particularly relates to securing customer sensitive information on private cloud platforms.

### BACKGROUND

Data security is a constant problem for various entities, especially for data centers which are often the target of hackers. While security systems are available to protect sensitive information at a datacenter, hackers still manage to access the data.

### BRIEF SUMMARY

A method for securing customer sensitive information on private cloud platforms is disclosed. An apparatus and computer program product also perform the functions of the method. The method includes receiving, at an on-premises computing system, sensitive information of a user. A local key of the on-premises computing system was previously encrypted by a master key stored at an off-premises computing system. The method includes sending the encrypted local key to the off-premises computing system for decryption, and receiving the decrypted local key in response to sending the encrypted local key to the off-premises computing system. The decrypted local key is decrypted from the received encrypted local key. The method includes decrypting a secret key assigned to the user, encrypting the sensitive information using the decrypted secret key, and storing the encrypted sensitive information.

An apparatus for securing customer sensitive information on private cloud platforms is disclosed includes a processor and a memory that stores code executable by the processor to receive, at an on-premises computing system, sensitive information of a user. A local key of the on-premises computing system was previously encrypted by a master key stored at an off-premises computing system. The code is executable by the processor to send the encrypted local key to the off-premises computing system for decryption, to receive the decrypted local key in response to sending the encrypted local key to the off-premises computing system, where the decrypted local key is decrypted from the received encrypted local key, to decrypt a secret key assigned to the user, to encrypt the sensitive information using the decrypted secret key, and to store the encrypted sensitive information.

A program product for securing customer sensitive information on private cloud platforms includes a computer readable storage medium and program code. The program code is configured to be executable by a processor to perform operations comprising receiving, at an on-premises computing system, sensitive information of a user. A local key of the on-premises computing system was previously encrypted by a master key stored at an off-premises computing system. The program code is further configured to be executable by the processor to perform operations comprising sending the encrypted local key to the off-premises computing system for decryption, receiving the decrypted local key in response to sending the encrypted local key to the off-premises computing system, where the decrypted local key is decrypted from the received encrypted local key, decrypting a secret key assigned to the user, encrypting the sensitive information using the decrypted secret key, and storing the encrypted sensitive information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for securing customer sensitive information on private cloud platforms;

FIG. 2 is a schematic block diagram illustrating one embodiment of a hardware/software domain and a crypto keys domain for securing customer sensitive information on private cloud platforms;

FIG. 3 is a schematic block diagram illustrating one embodiment of an apparatus for securing customer sensitive information on private cloud platforms;

FIG. 4 is a schematic block diagram illustrating another embodiment of an apparatus for securing customer sensitive information on private cloud platforms;

FIG. 5 is a schematic flow chart diagram illustrating one embodiment of a method for encrypting and storing customer sensitive information; and

FIG. 6 is a schematic flow chart diagram illustrating one embodiment of a method for retrieving and using customer sensitive information.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for securing customer sensitive information on private cloud platforms is disclosed. An apparatus and computer program product also perform the functions of the method. The method includes receiving, at an on-premises computing system, sensitive information of a user. A local key of the on-premises computing system was previously encrypted by a master key stored at an off-premises computing system. The method includes sending the encrypted local key to the off-premises computing system for decryption, and receiving the decrypted local key in response to sending the encrypted local key to the off-premises computing system. The decrypted local key is decrypted from the received encrypted local key. The method includes decrypting a secret key assigned to the user, encrypting the sensitive information using the decrypted secret key, and storing the encrypted sensitive information.

In some embodiments, the method includes retrieving the encrypted sensitive information in response to a request to use the sensitive information, sending the encrypted local key to the off-premises computing system for decryption, receiving the decrypted local key in response to sending the encrypted local key to the off-premises computing system, decrypting the secret key assigned to the user, decrypting the sensitive information using the decrypted secret key, and providing the decrypted sensitive information for use. In other embodiments, the method includes erasing the decrypted local key and the decrypted secret key after use in encryption or decryption and using or encrypting the sensitive information. In other embodiments, the off-premises computing system includes a software as a service (“SaaS”) running on a cloud computing system and a SaaS management layer of the SaaS encrypts and decrypts the local key using the master key.

In some embodiments, the method includes generating the local key at the on-premises computing system, where the local key is specific to the on-premises computing system, sending the local key to the off-premises computing system, receiving an encrypted version of the local key, and storing the encrypted local key on-premises. In other embodiments, the method includes generating the secret key at the on-premises computing system, where the secret key is specific to the user, encrypting the secret key using the local key, and storing the encrypted secret key on-premises. In other embodiments, the master key is generated at the off-premises computing system with use specific to the on-premises computing system.

In some embodiments, the on-premises computing system is a cloud computing system providing computing services to the user where the user is a client. In other embodiments, the on-premises computing system executes workloads in a virtual machine of controlled by the user. In other embodiments, the sensitive information is received from the off-premises computing system. In other embodiments, the sensitive information includes a password, an account number, a social security number, a credit card number, and/or personal information of the user.

An apparatus for securing customer sensitive information on private cloud platforms is disclosed includes a processor and a memory that stores code executable by the processor to receive, at an on-premises computing system, sensitive information of a user. A local key of the on-premises computing system was previously encrypted by a master key stored at an off-premises computing system. The code is executable by the processor to send the encrypted local key to the off-premises computing system for decryption, to receive the decrypted local key in response to sending the encrypted local key to the off-premises computing system, where the decrypted local key is decrypted from the received encrypted local key, to decrypt a secret key assigned to the user, to encrypt the sensitive information using the decrypted secret key, and to store the encrypted sensitive information.

In some embodiments, the code is further executable by the processor to retrieve the encrypted sensitive information in response to a request to use the sensitive information, send the encrypted local key to the off-premises computing system for decryption, receive the decrypted local key in response to sending the encrypted local key to the off-premises computing system, decrypt the secret key assigned to the user, decrypt the sensitive information using the decrypted secret key, and provide the decrypted sensitive information for use. In other embodiments, the code is further executable by the processor to erase the decrypted local key and the decrypted secret key after use in encryption or decryption and using or encrypting the sensitive information.

In other some embodiments, the code is further executable by the processor to generate the local key at the on-premises computing system, where the local key is specific to the on-premises computing system, to send the local key to the off-premises computing system, to receive an encrypted version of the local key, and to store the encrypted local key on-premises. In other embodiments, the code is further executable by the processor to generate the secret key at the on-premises computing system, where the secret key is specific to the user, to encrypt the secret key using the local key, and to store the encrypted secret key on-premises. In other embodiments, the off-premises computing system includes a SaaS running on a cloud computing system and a SaaS management layer of the SaaS encrypts and decrypts the local key using the master key.

A program product for securing customer sensitive information on private cloud platforms includes a computer readable storage medium and program code. The program code is configured to be executable by a processor to perform operations comprising receiving, at an on-premises computing system, sensitive information of a user. A local key of the on-premises computing system was previously encrypted by a master key stored at an off-premises computing system. The program code is further configured to be executable by the processor to perform operations comprising sending the encrypted local key to the off-premises computing system for decryption, receiving the decrypted local key in response to sending the encrypted local key to the off-premises computing system, where the decrypted local key is decrypted from the received encrypted local key, decrypting a secret key assigned to the user, encrypting the sensitive information using the decrypted secret key, and storing the encrypted sensitive information.

In some embodiments, the program code is further executable by the processor to perform operations comprising retrieving the encrypted sensitive information in response to a request to use the sensitive information, sending the encrypted local key to the off-premises computing system for decryption, receiving the decrypted local key in response to sending the encrypted local key to the off-premises computing system, decrypting the secret key assigned to the user, decrypting the sensitive information using the decrypted secret key, providing the decrypted sensitive information for use, and erasing the decrypted local key and the decrypted secret key after use in encryption or decryption. In other embodiments, the program code is further executable by the processor to perform operations comprising erasing the decrypted local key and the decrypted secret key after use in encryption or decryption and using or encrypting the sensitive information.

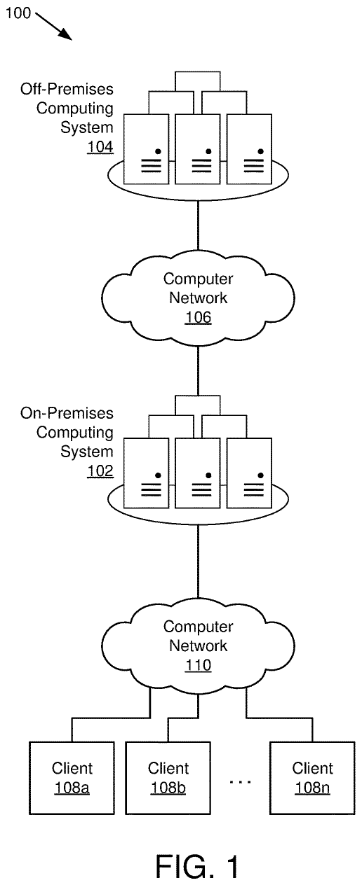

FIG. 1 is a schematic block diagram illustrating one embodiment of a system for securing customer sensitive information on private cloud platforms. The system 100 includes an on-premises computing system 102 and an off-premises computing system 104 connected by a computer network 106, and multiple clients 108a-108n (collectively or generically “108”) connected to the on-premises computing system 102 over another computer network 110, which are described below.

The on-premises computing system 102 includes an encryption apparatus (not shown) on one or more computing devices. The encryption apparatus protects customer sensitive information (or “sensitive information”) by encrypting the sensitive information using a secret key and storing the encrypted sensitive information on-premises. The secret key is encrypted using a local key, which is encrypted using a master key kept at the off-premises computing system 104. By having the encryption keys spread over multiple locations and having an encrypted version of the secret key and local key on the on-premises computing system 102, hackers will have a very difficult time accessing the sensitive information. The encryption apparatus is described further below.

The on-premises computing system 102, as used herein, includes computing devices controlled by a particular entity while the off-premises computing system 104 is not controlled by the entity. On-premises includes a location that may include one or more buildings, facilities, etc. with interconnected computing devices. In some embodiments, a portion of the on-premises computing system 102 is located remotely but is controlled by the entity. The off-premises computing system 104, in some embodiments, is a public system providing services to multiple entities where the entity controlling the on-premises computing system 102 uses software services of the off-premises computing system 104.

In some examples, the on-premises computing system 102 is a private cloud that services workloads from the clients 108. The private cloud includes computing resources to enable clients to submit workloads for processing by the private cloud. In some embodiments, the private cloud includes rack mounted servers, power supplies, storage devices, routers, switches, and the like. Often, a private cloud or other on-premises computing system 102 has a need to access an off-premises computing system 104. For example, an off-premises computing system 104 may have desirable resources that the owner of the on-premises computing system 102 might not want to duplicate.

One example of an off-premises computing system 104 that provides services accessed by the on-premises computing system 102 is a storage solution that has capabilities for mass storage that the owner of the on-premises computing system 102 desires to use. An example of such a system is the Amazon Web Services (“AWS”) Simple Storage Service (“S3”), which is an object storage service that provides scalability, data availability, performance, etc. In other embodiments, the off-premises computing system 104 provides specialized data processing solution, such as customer billing, video processing, or the like. The off-premises computing system 104 includes at least one computing device capable of communicating with the on-premises computing system 102, generating a master key, decrypting a local key, transmitting the local key, etc. One of skill in the art will recognize other off-premises computing systems 104 that are connected to an on-premises computing system 102.

While the depicted solution shows an on-premises computing system 102 as a data center, the on-premises computing system 102 may also take other forms. For example, the on-premises computing system 102 may be an edge computing system located at a store or at a processing hub for a retailer and the clients 108 include customer computing devices that interact with a website of the retailer. The customers may then input customer sensitive information, such as a password for the customer's account, credit card information, a social security number, or other customer data that needs to be protected from hackers and at least some of the employees of the retailer. The embodiments described herein are applicable to any on-premises computing system 102 that connects to an off-premises computing system 104 providing services to the on-premises computing system 102 where sensitive information is present and should be protected in a very secure way.

In some embodiments, the on-premises computing system 102 includes a computing device, such as a server, a workstation, a desktop computer, a mainframe computer, a rack-mounted server, etc. capable of encrypting and decrypting keys and data and capable of storing and accessing encrypted sensitive information. The on-premises computing system 102 also has an ability to connect to the off-premises computing system 104 for some type of computer service. The off-premises computing system 104, in some embodiments provides a software as a service (“SaaS”). The SaaS, in some embodiments, includes a SaaS management layer that handles encryption, decryption, creation of a master key, etc. and the on-premises computing system 102 communicates with the SaaS management layer of the off-premises computing system 104 to send an encrypted local key, to receive a decrypted local key after decryption, etc.

The clients 108, in some embodiments, are servers that submit workloads to the on-premises computing system 102. In some embodiments, the on-premises computing system 102 creates one or more virtual machines for a client 108 and the workloads execute on a virtual machine. In other embodiments, the clients 108 are other computing devices in a data center that submit workloads to the on-premises computing system 102 for execution. The customers submitting workloads from time to time upload sensitive information regarding the workloads, an access account, or the like. In other embodiments, the clients 108 are laptop computers, smartphones, tablets, desktop computers, etc. that are used by customers to create a customer account, purchase goods, shop for products, etc. The customers submit some sensitive information, such as a credit card number, a birth date, a social security number, a password, etc. and the submitted sensitive information is protected through encryption with the encryption apparatus. One of skill in the art will recognize other forms of the system 100 that has an on-premises computing system 102 connected to an off-premises computing system 104 that receives sensitive information for protection through encryption by the encryption apparatus.

The computer networks 106, 110, in some embodiments include overlapping elements. For example, both computer networks 106, 110 may include the Internet, part of a local area network (“LAN”), etc. The computer networks 106, 110 may be wired, wireless or a combination of both. The computer networks 106, 110 may include a LAN, a wide area network (“WAN”), a fiber optic network, a proprietary network, the Internet, a wireless connection, and/or the like. The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada. The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

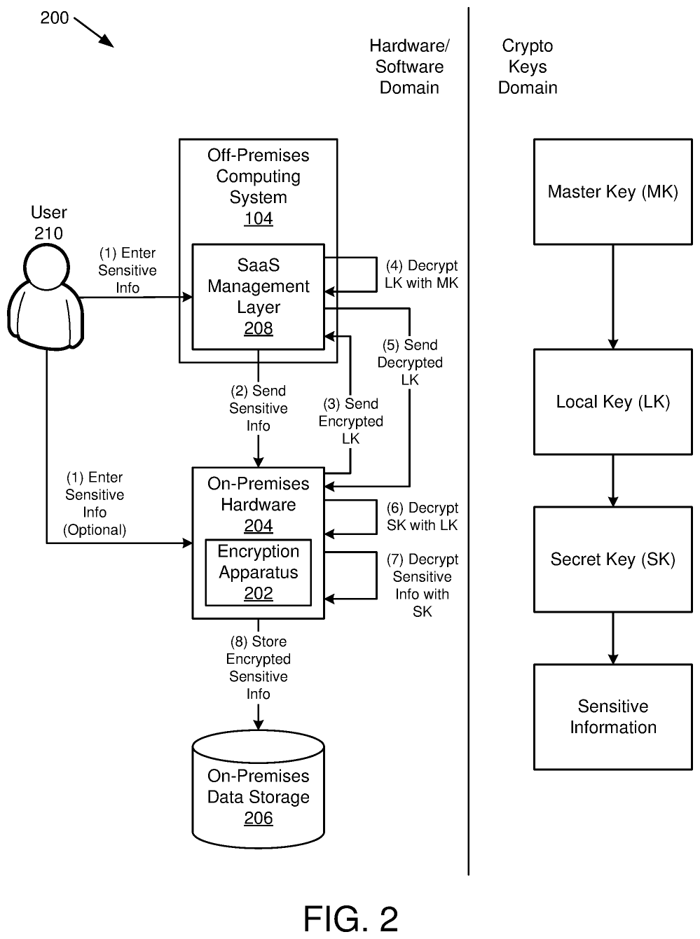

FIG. 2 is a schematic block diagram illustrating one embodiment 200 of a hardware/software domain and a crypto keys domain for securing customer sensitive information on private cloud platforms. The hardware/software domain includes an encryption apparatus 202 in on-premises hardware 204 and on-premises data storage 206. The encryption apparatus 202 is substantially similar to the encryption apparatus described with regard to the system 100 of FIG. 1. The on-premises hardware 204 and the on-premises data storage 206 are part of the on-premises computing system 102. The on-premises hardware 204 is a computing device capable of storing and accessing sensitive information, encrypting and decrypting keys and sensitive information, sending an encrypted local key, receiving a decrypted local key, and other encryption management tasks. The embodiment 200 includes the off-premises computing system 104 with a SaaS management layer 208.

A user 210 enters (1) sensitive information, in some embodiments, at the SaaS management layer 208, which then sends (2) the sensitive information to the on-premises hardware 204. The user 210, in other embodiments, sends the sensitive information using a client 108, a management node, or the like to the SaaS management layer 208. Alternatively, the on-premises hardware 204 receives (1) the sensitive information directly, for example, from a client 108. The encryption apparatus 202 receives (2) the sensitive information and sends (3) an encrypted local key to the SaaS management layer 208. The SaaS management layer decrypts (4) the local key using the master key and sends (5) the decrypted local key to the on-premises hardware 204.

The encryption apparatus 202 receives (5) the decrypted local key and decrypts (6) an encrypted secret key using the decrypted local key. The encryption apparatus 202 encrypts (7) the sensitive information using the decrypted secret key and stores (8) the encrypted sensitive information on the on-premises data storage 206. After the operations (1)-(8) described above, the encryption apparatus 202 erases the decrypted local key, the decrypted secret key and the unencrypted sensitive information. In some embodiments, the encryption apparatus 202 stores the unencrypted sensitive information, the decrypted local key, the decrypted secret key, and any other sensitive data in volatile memory of the on-premises hardware 204 so that the unencrypted information, the decrypted local key, the decrypted secret key, etc. can be erased without leaving a copy on the on-premises computing system 102. Likewise, in some embodiments the SaaS management layer 208 stores the decrypted local key in volatile memory and erases the decrypted local key after the decrypted local key is transmitted to the on-premises hardware 204.

The crypto keys domain is intended to show that the master key is used to encrypt and decrypt the local key, the decrypted local key is used to encrypt and decrypt the secret key, the decrypted secret key is used to encrypt and decrypt the sensitive information. The master key, the local key, and the secret key are cryptography keys. Typically, the master key, the local key, and the secret key are each generated using information specific to the purpose of the key. For example, the local key may be generated using an identifier specific to a particular computer located in the on-premises computing system 102. A particular secret key is specific to a customer and may be generated using a customer identifier or other information specific to the customer.

The master key, in some embodiments, is specific to the on-premises computing system 102 and may be generated using some information specific to a computer, a router, an internet protocol (“IP”) address, etc. of the on-premises computing system 102. Thus, the SaaS management layer 208 may include multiple master keys for different on-premises computing systems and the encryption apparatus 202 may include numerous secret keys, each correlating to a specific customer. In some embodiments, the master key, the local key, and the secret key are private keys and a public key may be publicly available. One of skill in the art will recognize other formats and generation methods for the master key, the local key, and the secret key.

In some embodiments, the sensitive information is used to access customer information on the off-premises computing system 104. If a hacker breaks into the off-premises computing system 104, the information located there is either non-sensitive and therefore not a problem if seen or copied by the hacker, or is protected by the sensitive information located elsewhere. The hacker might be able to access the master key, but without context or a mapping to the on-premises computing system 102, the master key would be useless to the hacker. If another hacker gets into the on-premises computing system 102, the sensitive information, the secret key, and the local key are all encrypted and the hacker would then have no knowledge of how to get the master key on the SaaS management layer 208. Making a link between the local key on the on-premises computing system 102 and the master key on the SaaS management layer 208 would be very difficult for a hacker. Thus, the embodiments described herein provide a more robust encryption system than other current encryption systems.

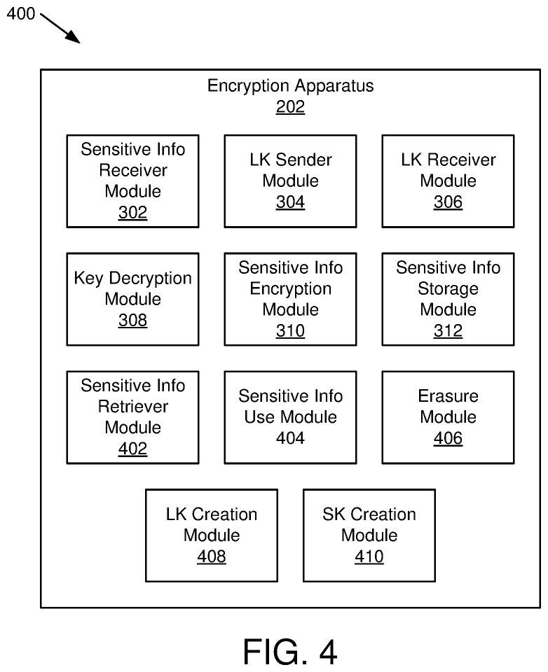

While the process displayed in the embodiment 200 of FIG. 2 depicts encryption of received sensitive information, a similar process may be used to service a request to access the sensitive information. Other related processes, such as generating a master key, local key and/or secret key are discussed below with regard to the apparatus 400 of FIG. 4.

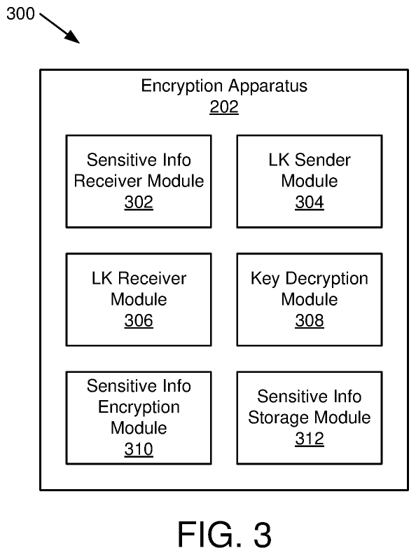

FIG. 3 is a schematic block diagram illustrating one embodiment of an apparatus 300 for securing customer sensitive information on private cloud platforms. The apparatus 300 includes an embodiment of the encryption apparatus 202 that includes a sensitive info receiver module 302, a local key sender module 304, a local key receiver module 306, a key decryption module 308, a sensitive info encryption module 310, and a sensitive info storage module 312, which are described below. In some embodiments, the encryption apparatus 202 is implemented with program code stored on a computer readable storage device on the on-premises computing system 102. The computer readable storage device is non-transitory and is non-volatile. The program code is executable on a processor of the on-premises hardware 204. In other embodiments, the encryption apparatus 202 is implemented with a programmable hardware device, such as an FPGA. In other embodiments, all or a portion of the encryption apparatus 202 is implemented with hardware circuits.

The apparatus 300 includes a sensitive info receiver module 302 configured to receive, at the on-premises computing system 102, sensitive information of a user 210. A local key of the on-premises computing system 102 was previously encrypted by a master key stored at the off-premises computing system 104. In some embodiments, the sensitive info receiver module 302 receives the sensitive information from the off-premises computing system 104, such as from a SaaS management layer 208. In other embodiments, the sensitive info receiver module 302 receives the sensitive information from a client 108, from an input device connected to the on-premises hardware 204, or other source known to those of skill in the art.

The local key is an encryption key that is used for data at the on-premises computing system 102. The local key is used exclusively for data on the on-premises computing system 102 and not for other computing systems. In some embodiments, the local key is used to encrypt and decrypt secret keys associated with various customers, virtual machines, etc. The master key is stored at the off-premises computing system 104 and in some embodiments is specific to the on-premises computing system 102.

The apparatus 300 includes a local key sender module 304 configured to send the encrypted local key to the off-premises computing system 104 for decryption. For example, the local key sender module 304 retrieves a copy of the encrypted local key from a storage device (e.g. on-premises data storage 206) within the on-premises computing system 102. The off-premises computing system 104 decrypts the encrypted local key, for example, in a SaaS management layer 208 of the off-premises computing system 104, and sends the decrypted local key to the on-premises computing system 102. Typically, the local key sender module 304 sends the encrypted local key in response to some need for encrypting or decrypting sensitive information.

The apparatus 300 includes a local key receiver module 306 configured to receive the decrypted local key in response to the local key sender module 304 sending the encrypted local key to the off-premises computing system 104. The decrypted local key is decrypted from the received encrypted local key at the off-premises computing system 104. For example, when the on-premises computing system 102 receives the decrypted local key, the decrypted local key is routed to the local key receiver module 306 or the local key receiver module 304 is aware of receipt of the decrypted local key and retrieves the decrypted local key from a buffer, register, etc.

The apparatus 300 includes a key decryption module 308 configured to decrypt a secret key assigned to the user 210 that sent the sensitive information. The user 210 may be associated with a customer. For example, the customer may be sending workloads to the on-premises computing system 102 for processing and data from the workloads may be stored on the off-premises computing system 104 so the sensitive information may be used to access an account of the customer on the off-premises computing system 104.

The apparatus 300 includes a sensitive info encryption module 310 configured to encrypt the sensitive information using the decrypted secret key and a sensitive info storage module 312 configured to store the encrypted sensitive information. The decrypted secret key is specific to the user 210. In some examples, the sensitive info storage module 312 stores the encrypted sensitive information in the on-premises data storage 206. The sensitive info storage module 312 stores the encrypted sensitive information on-premises, for example, to avoid having sensitive information on a public cloud of the off-premises computing system 104.

FIG. 4 is a schematic block diagram illustrating another embodiment of an apparatus 400 for securing customer sensitive information on private cloud platforms. The apparatus 400 includes another embodiment of the encryption apparatus 202 that includes a sensitive info receiver module 302, a local key sender module 304, a local key receiver module 306, a key decryption module 308, a sensitive info encryption module 310, and a sensitive info storage module 312, which are substantially similar to those described above in relation to the apparatus 300 of FIG. 3. The encryption apparatus 202 includes one or more of a sensitive info retriever module 402, a sensitive info use module 404, an erasure module 406, a local key creation module 408, and a secret key creation module 410, which are described below. The encryption apparatus 202 may be implemented the same way as the encryption apparatus 202 of FIG. 3.

The apparatus 400, in some embodiments, includes a sensitive info retriever module 402 configured to retrieve the encrypted sensitive information in response to a request to use the sensitive information. For example, the sensitive information may be a password and the user 210 may want to use the password to access an account, data, etc. In some embodiments, the request from the user 210 comes directly from a user 210. In other embodiments, the request comes from a client 108 of the user 210 as part of a process to service the workloads. In other embodiments, the request is part of an online sales process and the sensitive information is a credit card number. One of skill in the art will recognize other requests to access the sensitive information.

In response to the sensitive info retriever module 402 retrieving the encrypted sensitive information or in response to the request, the local key sender module 304 sends the encrypted local key to the off-premises computing system 104 for decryption, the local key receiver module 306 receives the decrypted local key in response to the local key sender module 304 sending the encrypted local key to the off-premises computing system 104, the key decryption module 308 decrypts the secret key assigned to the user 210, and the sensitive info encryption module 310 decrypts the sensitive information using the decrypted secret key.

The apparatus 400, in the embodiment, includes a sensitive info use module 404 configured to provide the decrypted sensitive information for use by the user 210. In some embodiments, the sensitive info use module 404 provides the sensitive information to an application that uses the sensitive information. For example, the sensitive info use module 404 may provide the unencrypted sensitive information in the form of a password to an application being accessed by the user 210. In other embodiments, the sensitive info use module 404 provides the decrypted sensitive information to the user 210. One of skill in the art will recognize other ways that the sensitive info use module 404 is able to provide the decrypted sensitive information for use.

The apparatus 400 includes an erasure module 406 configured to erase the decrypted local key and the decrypted secret key after use in encryption or decryption and using or encrypting the sensitive information. In some embodiments, the erasure module 406 erases the decrypted local key and the decrypted secret key after use in encryption or decryption and using or encrypting the sensitive information from every location where stored on the on-premises computing system 102. In some embodiments, to facilitate easy erasure the decrypted local key, the decrypted secret key and the unencrypted sensitive information are stored in volatile memory and the erasure module 406 erases the decrypted keys and the unencrypted sensitive information from volatile memory.

For example, where the sensitive information is initially received by the sensitive info receiver module 302 and the modules 304-312 of the apparatus 300 of FIG. 3 may store the decrypted local key, the decrypted secret key and the unencrypted sensitive information are stored in volatile memory, the erasure module 406 erases the decrypted local key, the decrypted secret key and the unencrypted sensitive information from the volatile memory. Similarly, when a request to use the sensitive information received, the modules 402, 404, 304-310 may again store the decrypted local key, the decrypted secret key and the unencrypted sensitive information are stored in volatile memory and the erasure module 406 may then erase the decrypted local key, the decrypted secret key and the decrypted sensitive information from volatile memory.

The apparatus 400, in some embodiments, includes a local key creation module 408 configured to generate the local key at the on-premises computing system 102, where the local key is specific to the on-premises computing system 102. The local key creation module 408 is also configured to send the local key to the off-premises computing system 104, receive an encrypted version of the local key and store the encrypted local key on-premises. For example, the local key creation module 408 may store the encrypted local key in the on-premises data storage 206. In some embodiments, the local key is mapped to a particular master key at the off-premises computing system 104. The off-premises computing system 104 generates a master key, in some embodiments, specifically for use in decrypting the encrypted local key.

In some embodiments, the apparatus 400 includes a secret key creation module 410 configured to generate the secret key at the on-premises computing system 102, where the secret key is specific to the user 210, to encrypt the secret key using the local key, and to store the encrypted secret key on-premises, for example, in the on-premises data storage 206. For example, the secret key creation module 410 may generate a secret key for each user 210 or customer. In some embodiments, the secret key creation module 410 generates multiple secret keys for a user 210 or customer.

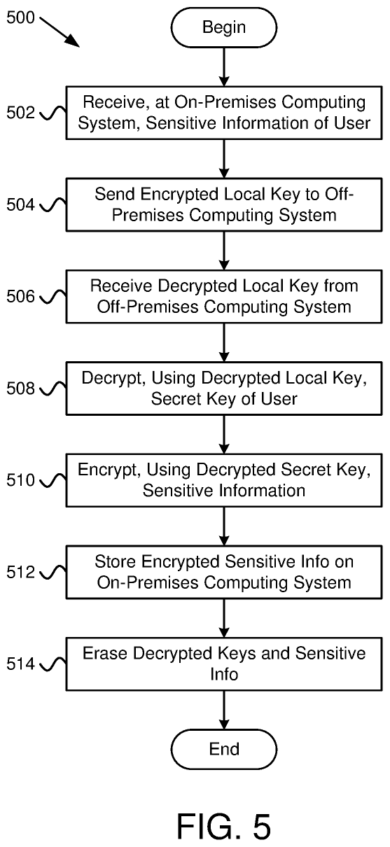

FIG. 5 is a schematic flow chart diagram illustrating one embodiment of a method 500 for encrypting and storing customer sensitive information. The method 500 begins and receives 502, at an on-premises computing system 102, sensitive information of a user 210. A local key of the on-premises computing system 102 was previously encrypted by a master key stored at an off-premises computing system 104. The method 500 receives 502 the sensitive information, in various embodiments, from a user 210 the off-premises computing system 104, from the user 210, from a client 108, etc. The method 500 sends 504 the encrypted local key to the off-premises computing system 104 for decryption and receives 506 the decrypted local key in response to sending the encrypted local key to the off-premises computing system 104. The decrypted local key is decrypted from the received encrypted local key. The method 500 decrypts 508, using the decrypted local key, a secret key assigned to the user 210, and encrypts 510 the sensitive information using the decrypted secret key. The method 500 stores 512 the encrypted sensitive information and erases 514 the decrypted local key, the decrypted secret key and the unencrypted sensitive information, and the method 500 ends. In various embodiments, all or a portion of the method 500 is implemented with the sensitive info receiver module 302, the local key sender module 304, the local key receiver module 306, the key decryption module 308, the sensitive info encryption module 310, the sensitive info storage module 312 and/or the erasure module 406.

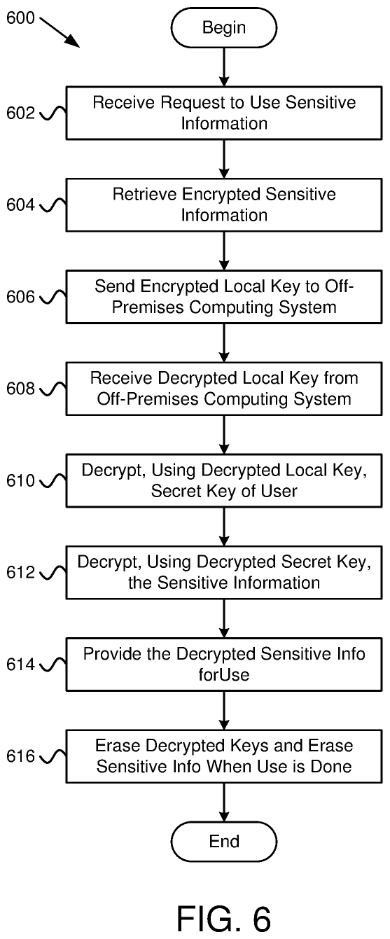

FIG. 6 is a schematic flow chart diagram illustrating one embodiment of a method 600 for retrieving and using customer sensitive information. The method 600 begins and receives 602 a request to use the sensitive information. For example, the method 600 may receive the request from the user 210 or a customer associated with the sensitive information. The method 600 receives 602 the request to use the sensitive information, in various embodiments, from a user 210 via the off-premises computing system 104, from the user 210, from a client 108, etc. The method 600 retrieves 604 the encrypted sensitive information. A local key of the on-premises computing system 102 was previously encrypted by a master key stored at an off-premises computing system 104.

The method 600 sends 606 the encrypted local key to the off-premises computing system 104 for decryption and receives 608 the decrypted local key in response to sending the encrypted local key to the off-premises computing system 104. The decrypted local key is decrypted from the received encrypted local key. The method 600 decrypts 610, using the decrypted local key, a secret key assigned to the user 210 and decrypts 612 the sensitive information using the decrypted secret key. The method 600 provides 614 the decrypted sensitive information for use and erases 616 the decrypted local key, the decrypted secret key and erases 616, after use, the decrypted sensitive information, and the method 600 ends. In some embodiments, the method 600 retrieves the unencrypted sensitive information after decrypting 610 the secret key. In various embodiments, all or a portion of the method 600 is implemented with the sensitive info retriever module 402, the local key sender module 304, the local key receiver module 306, the key decryption module 308, the sensitive info encryption module 310, the sensitive info use module 404, and/or the erasure module 406.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, at an on-premises computing system, sensitive information of a user, wherein a local key of the on-premises computing system was previously encrypted by a master key stored at an off-premises computing system;
sending the encrypted local key to the off-premises computing system for decryption;
receiving the decrypted local key in response to sending the encrypted local key to the off-premises computing system, the decrypted local key being decrypted from the received encrypted local key;
decrypting a secret key assigned to the user;
encrypting the sensitive information using the decrypted secret key; and
storing the encrypted sensitive information.

2. The method of claim 1, further comprising:
retrieving the encrypted sensitive information in response to a request to use the sensitive information;
sending the encrypted local key to the off-premises computing system for decryption;
receiving the decrypted local key in response to sending the encrypted local key to the off-premises computing system;
decrypting the secret key assigned to the user;
decrypting the sensitive information using the decrypted secret key; and
providing the decrypted sensitive information for use.

3. The method of claim 2, further comprising erasing the decrypted local key and the decrypted secret key after use in encryption or decryption and using or encrypting the sensitive information.

4. The method of claim 1, wherein the off-premises computing system comprises a software as a service (“SaaS”) running on a cloud computing system and a SaaS management layer of the SaaS encrypts and decrypts the local key using the master key.

5. The method of claim 1, further comprising:
generating the local key at the on-premises computing system, wherein the local key is specific to the on-premises computing system;
sending the local key to the off-premises computing system;
receiving an encrypted version of the local key; and
storing the encrypted local key on-premises.

6. The method of claim 1, further comprising:
generating the secret key at the on-premises computing system, wherein the secret key is specific to the user;
encrypting the secret key using the local key; and
storing the encrypted secret key on-premises.

7. The method of claim 1, wherein the master key is generated at the off-premises computing system with use specific to the on-premises computing system.

8. The method of claim 1, wherein the on-premises computing system is a cloud computing system providing computing services to the user, wherein the user is a client.

9. The method of claim 8, wherein the on-premises computing system executes workloads in a virtual machine of controlled by the user.

10. The method of claim 1, wherein the sensitive information is received from the off-premises computing system.

11. The method of claim 1, wherein the sensitive information comprises a password, an account number, a social security number, a credit card number, and/or personal information of the user.

12. An apparatus comprising:
a processor; and
a memory that stores code executable by the processor to:
receive, at an on-premises computing system, sensitive information of a user, wherein a local key of the on-premises computing system was previously encrypted by a master key stored at an off-premises computing system;
send the encrypted local key to the off-premises computing system for decryption;
receive the decrypted local key in response to sending the encrypted local key to the off-premises computing system, the decrypted local key being decrypted from the received encrypted local key;
decrypt a secret key assigned to the user;
encrypt the sensitive information using the decrypted secret key; and store the encrypted sensitive information.

13. The apparatus of claim 12, wherein the code is further executable by the processor to:
retrieve the encrypted sensitive information in response to a request to use the sensitive information;
send the encrypted local key to the off-premises computing system for decryption;
receive the decrypted local key in response to sending the encrypted local key to the off-premises computing system;
decrypt the secret key assigned to the user;
decrypt the sensitive information using the decrypted secret key; and
provide the decrypted sensitive information for use.

14. The apparatus of claim 13, wherein the code is further executable by the processor to erase the decrypted local key and the decrypted secret key after use in encryption or decryption and using or encrypting the sensitive information.

15. The apparatus of claim 12, wherein the code is further executable by the processor to:
generate the local key at the on-premises computing system, wherein the local key is specific to the on-premises computing system;
send the local key to the off-premises computing system;
receive an encrypted version of the local key; and
store the encrypted local key on-premises.

16. The apparatus of claim 12, wherein the code is further executable by the processor to:
generate the secret key at the on-premises computing system, wherein the secret key is specific to the user;
encrypt the secret key using the local key; and
store the encrypted secret key on-premises.

17. The apparatus of claim 12, wherein the off-premises computing system comprises a software as a service (“SaaS”) running on a cloud computing system and a SaaS management layer of the SaaS encrypts and decrypts the local key using the master key.

18. A program product comprising a computer readable storage medium and program code, the program code being configured to be executable by a processor to perform operations comprising:
receiving, at an on-premises computing system, sensitive information of a user, wherein a local key of the on-premises computing system was previously encrypted by a master key stored at an off-premises computing system;
sending the encrypted local key to the off-premises computing system for decryption;
receiving the decrypted local key in response to sending the encrypted local key to the off-premises computing system, the decrypted local key being decrypted from the received encrypted local key;
decrypting a secret key assigned to the user;
encrypting the sensitive information using the decrypted secret key; and
storing the encrypted sensitive information.

19. The program product of claim 18, wherein the program code is further executable by the processor to perform operations comprising:
retrieving the encrypted sensitive information in response to a request to use the sensitive information;
sending the encrypted local key to the off-premises computing system for decryption;
receiving the decrypted local key in response to sending the encrypted local key to the off-premises computing system;
decrypting the secret key assigned to the user;
decrypting the sensitive information using the decrypted secret key;
providing the decrypted sensitive information for use; and
erasing the decrypted local key and the decrypted secret key after use in encryption or decryption.

20. The program product of claim 19, wherein the program code is further executable by the processor to perform operations comprising erasing the decrypted local key and the decrypted secret key after use in encryption or decryption and using or encrypting the sensitive information.
